(19) United States
(12) Patent Application Publication
(10) Pub. No.: US 2023/0160745 A1
(43) Pub. Date: May 25, 2023

(54) METHOD AND DEVICE FOR DETERMINING A GLOBAL IRRADIANCE OF SOLAR RADIATION

(71) Applicant: DEUTSCHES ZENTRUM FÜR LUFT- UND RAUMFAHRT E.V., 53227 Bonn (DE)

(72) Inventors: Niklas BLUM, Almeria (ES); Stefan WILBERT, Almeria (ES)

(73) Assignee: DEUTSCHES ZENTRUM FÜR LUFT- UND RAUMFAHRT E.V., 53227 Bonn (DE)

(21) Appl. No.: 17/917,446

(22) PCT Filed: Apr. 26, 2021
(86) PCT No.: PCT/EP2021/060871

§ 371 Date: Oct. 6, 2022

(30) Foreign Application Priority Data
Apr. 28, 2020 (DE) 10 2020 111 590.3

(51) Int. Cl. G01J 1/42; G01J 1/04

(52) U.S. Cl. CPC G01J 1/42; G01J 1/0411; G01J 2001/4266

(57) ABSTRACT

A method and a device are provided for determining a global irradiance of solar radiation, and/or at least one of the components thereof, in a plane, wherein the components include direct radiation, diffuse radiation, and radiation reflected on the ground, with a device including at least one radiation sensor unit, a camera, and an evaluation unit which is provided for evaluating measurement data from the radiation sensor unit and/or from the camera. The radiation sensor unit for determining the irradiance of solar radiation is provided in a field of view of 180° over a plane. The camera for detecting a field of view of 180° is provided over a plane. A global irradiance of the solar radiation is measured and converted into the global irradiance and/or into one or more of the components thereof in the horizontal plane and/or in the plane inclined with respect to the horizontal plane.

### BACKGROUND AND SUMMARY

The invention relates to a method and a device for determining a global irradiance of solar radiation and/or at least one of the components thereof, in a plane, in particular in a horizontal plane and/or in a plane inclined with respect to the horizontal plane, the components being direct radiation, diffuse radiation, radiation reflected on the ground.

For solar technology applications, for example with fixed or tracked flat collectors or photovoltaic modules, precise measurements of a global irradiance of solar radiation in arbitrary planes (GTI) and with a high temporal resolution are of great interest.

Pyranometers can be used to measure irradiance from the hemisphere above the sensor plane. Pyranometers provide fairly accurate measurements of the GTI, but only for the plane used when the pyranometer was installed.

For example, a device is known from US 20160334123 A1 in which a pyranometer is used to measure the irradiance of solar radiation. Alternatively, the pyranometer is replaced by a camera.

Since the radiation measurements are necessary for planning before the construction of a solar power plant and the ideal angle of inclination or the tracking form of the collectors are not yet known at this point in time, inclined pyranometers alone are not sufficient.

In addition, for the accurate modeling of solar power plants or the enemy input in buildings, a division of the global tilted irradiance (GTI) into direct normal irradiance (DNI) and diffuse irradiance in the inclined plane (DifTI) is useful. In practice, therefore, the GTI is estimated from a measurement of the global horizontal irradiance (GHI) or the DNI and GHI via transposition models. Additional, complex and high-maintenance measurement technology is required to measure DNI and horizontal diffuse irradiance (DHI). A pyrheliometer tracking the sun measures the DNI. A pyranometer with a shadow ball tracking the sun measures the DHI. If only GHI is measured, DNI and DHI can be obtained via a decomposition model. The use of transposition and especially decomposition models is associated with large errors.

Cloud cameras were used to continuously determine the absolute radiation density or radiance distribution of the sky over all angular ranges and with high temporal resolution. Special laboratory setups with an additional tracker, shadow band or a specially designed cloud camera for this purpose were used.

The following publications are mentioned as examples: López-Álvarez, M. A. et al., “Using a trichromatic CCD camera for spectral skylight estimation”, Applied Optics, 2008, vol. 47(34). H31-H38.); Rossini, E. G., Krenzinger, A “Maps of sky relative radiance and luminance distributions acquired with a monochromatic CCD camera”, Solar Energy, 2007 vol. 81(11), 1323-1332: doi:10.1016/j.solener.2007.06.013), Schade, N. H. et al., “Enhanced solar global irradiance during cloudy sky conditions”, Meteorologische Zeitschrift, 2007, vol. 16(3), 295-303; Feister, U. et al., “Ground-based cloud images and sky radiances in the visible and near infrared region from whole sky imager measurements”, EUMETSAT Satellite Application Facility Workshop, German Weather Service and World Meteorological Organization, 2000. Sky radiance distributions have been used as a reference for cloud detection, such as, for example, in the publication by Cazorla, A. et al., “Development of a sky imager for cloud cover assessment”. JOSA A, 2008, vol. 25(1), 29-39.

However, camera systems described in the literature can only determine the radiance distribution of the sky outside the solar disk. Various systems determine the DNI from camera images. Machine learning has been used to derive DNI and DHI from camera images, see for example Schmidt, T., et al., “Retrieving direct and diffuse radiation with the use of sky imager pictures”, 2015, EGU General Assembly Conference Abstracts.

The DHI was calculated from the radiance distribution of the sky, which is determined from the image of a specially constructed cloud camera, and the DNI estimated from a “smearing” effect of the sun disk in the camera image, see for example Kurtz, B., Kleissl, J. “Measuring diffuse, direct, and global irradiance using a sky imager”, Solar Energy, 2017, vol. 141, 311-322.

Global horizontal irradiance (GHI) can be determined from both parts taken together.

It is desirable to provide an improved method for determining a global irradiance of solar radiation and/or at least one of the components thereof in a horizontal plane and in a plane inclined with respect to the horizontal plane.

It is also desirable to create a device for carrying out such a method.

According to one aspect of the invention, a method is proposed for determining a global irradiance of solar radiation and/or at least one of the components thereof in a plane, in particular in a horizontal plane and/or in a plane inclined with respect to the horizontal plane, the components comprising direct radiation, diffuse radiation, radiation reflected on the ground, with a device comprising at least one radiation sensor unit, a camera, and an evaluation unit, which is provided for evaluating measurement data from the radiation sensor unit and/or from the camera. The radiation sensor unit is provided for determining the irradiance of solar radiation in a field of view of 180° above a plane. The camera is designed to detect a field of view of 180° over a plane.

Here, a global irradiance of the solar radiation is measured and converted into the global irradiance and/or into one or more of the components thereof in the horizontal plane and/or in a plane inclined with respect to a horizontal plane.

Advantageously, radiation sensor unit and camera can detect the same area above the horizontal plane. The respective plane represents the limitation of the respective field of view of the camera or the radiation sensor unit.

For example, the radiation sensor unit and the camera can be arranged on an axis which is typically oriented in a north-south direction. In this case, the radiation sensor unit is arranged north of the camera in the northern hemisphere and south of the camera in the southern hemisphere.

A pyranometer, in particular a thermopile pyranometer, can advantageously be used as the radiation sensor unit, and a cloud camera, such as, for example, a Mobotix Q25 surveillance camera can be used as the camera. In an advantageous configuration, both instruments are arranged horizontally leveled at the same height in the immediate vicinity of one another.

The red-green-blue (RGB) color channels of the camera image are weighted and summed. The weighting of the channels ensures that the camera's sensitivity is as uniform as possible in the visible wavelength range. This gray value is multiplied by a broadband correction to account for radiation at wavelengths outside the camera's measurement range.

Using a geometric internal and external standard calibration for cloud cameras, a sky range (azimuth and zenith angle) is specified for each pixel of the camera image. As a result, an estimate of the radiance distribution of the sky is obtained.

A luminance distribution is calculated analogously to the radiance distribution. For this purpose, the RGB color channels are weighted according to the sensitivity of the human eye before summation. Integration of the luminance distribution over all angular ranges provides a measured value of the illuminance. The illuminance output by the camera and calculated using the camera image are compared. The radiance distribution is scaled according to the ratio of both values in order to compensate for an influence of the camera control on the sensitivity of the camera.

The area of the solar disk is masked. For a horizontal or tilted plane evaluated, each area of sky in the radiance image is weighted according to a projection into the plane. Integration of the radiance distribution over all areas of the sky that are in the field of view of the inclined plane provides the diffuse irradiance of the respective plane originating from the sky.

The horizontal diffuse irradiance (DHI) is calculated accordingly. The diffuse irradiance in the plane of the pyranometer is also calculated accordingly. The direct normal irradiance (DNI) is calculated from the comparison to the global irradiance measured by means of a pyranometer and with knowledge of the current position of the sun.

In an advantageous embodiment, the pyranometer can be arranged horizontally. In this case, the pyranometer directly measures the global horizontal irradiance (GHI). Otherwise, GHI can be calculated analogously to global tilted irradiance (GTI), based on the measurement of the pyranometer and the cloud camera image.

To correct for refraction effects in the camera lens, the first estimate of the DHI and all other calculated diffuse irradiances, in particular the diffuse irradiance in the plane of the pyranometer, are reduced by a part of the DNI. The DNI is then recalculated.

Finally, the GTI in an evaluated plane results from a direct part, a diffuse part from the sky and a part reflected on the ground. The DNI is projected into the evaluated plane and thus results in the direct part. Diffuse irradiance is calculated from the camera image for this plane, as described above. The reflected part is obtained as GHI multiplied by the albedo of the ground and the term

(1—cos(inclination angle of the inclined plane against horizontal))/2.

According to a favorable configuration of the method, for converting the global irradiance of the solar radiation determined with the radiation sensor unit in the plane of the radiation sensor unit into the global irradiance and/or into at least one of the components thereof in the horizontal and/or inclined plane, at least one of the quantities of radiation reflected on the ground, and/or diffuse radiation in the horizontal and/or inclined plane, in particular in the plane of the radiation sensor unit, and/or the position of the sun in the radiation measurement, and/or a sensor-specific correction factor, which comprises in particular lens parameters of the camera, can be used. Factors of the position of the sun that influence the radiation measurement can be taken into account in the conversion.

In this way, the global irradiance and components thereof in a horizontal and/or inclined plane can be determined with high accuracy from the measurement data from the radiation sensor unit together with the measurement data from the camera.

According to a favorable configuration of the method, for converting measured values of the camera at least one of the quantities of a ratio of a broadband radiation to the part of the radiation registered by the camera and/or an intensity of RGB channels of the camera and/or an internal and/or external calibration of the camera and/or an inclination and orientation of the sensor of the camera and/or an inclination and orientation of the inclined plane and/or the position of the sun in the radiation measurement and/or a camera sensitivity, which is determined from an illuminance of the camera and/or the spectral sensitivity of the RGB channels and/or recording settings and/or the RGB camera image and/or the internal and/or external calibration of the camera, can be used.

Factors of the position of the sun that influence the radiation measurement can be taken into account in the conversion. In this way, the global irradiance and components thereof in the horizontal and/or inclined plane can be determined with high accuracy from the measurement data from the camera together with the measurement data from the radiation sensor unit.

According to a favorable configuration of the method, image information of the camera for converting the global irradiance in the plane of the radiation sensor unit into the global irradiance and/or into at least one of the components thereof can be included in another horizontal and/or inclined plane. In particular, the combination of the image information of the camera and of measured values from the radiation sensor unit can be used to reduce uncertainty caused by image artifacts. As a result, the accuracy of the method can be increased.

According to a favorable configuration of the method, the determination of the direct radiation as a component of the global irradiance in an arbitrary plane can be carried out with the steps of:

(i) determining radiation reflected on the ground by means of albedo, inclination and orientation of the inclined plane, and a measured value of the global irradiance in the plane of the radiation sensor unit; (ii) determining a direct radiation in the plane of the radiation sensor unit by subtracting the measured value of the diffuse radiation, evaluated for the plane of the radiation sensor unit, and the radiation reflected on the ground, evaluated for the plane of the radiation sensor unit, from the global irradiance in the plane of the radiation sensor unit; (iii) determining a direct normal irradiance by reversing the projection into the plane of the radiation sensor unit by means of the position of the sun calculated from location and time; (iv) determining a lens refraction correction by multiplying the direct normal irradiance by a correction factor, which in particular comprises lens parameters of the camera; (v) determining the corrected direct radiation by adding the direct radiation in the plane of the radiation sensor unit and the lens refraction correction, and inverting the projection into the plane of the radiation sensor unit and projection into the arbitrary plane.

According to a favorable configuration of the method, the determination of the diffuse radiation of solar radiation as a component of the global irradiance in an arbitrary plane can be carried out with the steps of: (i) determining a radiation reflected on the ground by means of albedo, inclination and orientation of the inclined plane, and a measured value of the global irradiance in the plane of the radiation sensor unit; (ii) determining the direct radiation in the plane of the radiation sensor unit by subtracting the measured value of the diffuse radiation, evaluated for the plane of the radiation sensor unit, and the radiation reflected on the ground, evaluated for the plane of the radiation sensor unit, from the global irradiance in the plane of the radiation sensor unit; (iii) determining a direct normal irradiance by reversing the projection into the plane of the radiation sensor unit by means of the position of the sun calculated from location and time; (iv) determining a lens refraction correction by multiplying the direct normal irradiance by a correction factor, which in particular comprises lens parameters of the camera; (vi) determining the corrected diffuse radiation by subtracting the lens refraction correction from the diffuse radiation, evaluated for the arbitrary plane.

According to a favorable configuration of the method, the determination of the global irradiance of the solar radiation in the horizontal and/or inclined plane can be carried out with the steps of: (i) determining radiation reflected on the ground by means of albedo, inclination and orientation of the inclined plane, and a measured value of the global irradiance in the plane of the radiation sensor unit; (ii) determining the direct radiation in the plane of the radiation sensor unit by subtracting the measured value of the diffuse radiation, evaluated for the plane of the radiation sensor unit, and the radiation reflected on the ground, evaluated for the plane of the radiation sensor unit, from the global irradiance in the plane of the radiation sensor unit; (iii) determining a direct normal irradiance by reversing the projection into the plane of the radiation sensor unit by means of the position of the sun calculated from location and time; (iv) determining a lens refraction correction by multiplying the direct normal irradiance by a correction factor, which in particular comprises lens parameters of the camera; (v) adding the direct radiation in the plane of the radiation sensor unit and the lens refraction correction, and inverting the projection into the plane of the radiation sensor unit and projection into the horizontal and/or inclined plane; (vi) subtracting the lens refraction correction from the diffuse radiation, evaluated for the horizontal plane and/or the inclined plane; (vii) determining the global irradiance in the horizontal and/or inclined plane by summing the radiation reflected on the ground, the direct radiation in the horizontal and/or inclined plane, and the diffuse radiation, evaluated for the horizontal and/or inclined plane. This allows the global irradiance in a horizontal and/or inclined plane to be determined with high accuracy from the measurement data from the radiation sensor unit together with the measurement data from the camera.

The lens refraction causes an overestimation of the diffuse radiation and thus an underestimation of the direct radiation. This effect can be corrected by subtracting the overestimate from the diffuse radiation and adding it to the direct radiation.

According to a favorable configuration of the method, a determination of the diffuse radiation in the horizontal and/or inclined plane, in particular in the plane of the radiation sensor unit, can be carried out with the steps of: (i) determining a broadband correction factor from the ratio of broadband radiation to the part registered by the camera by means of the daylight spectrum and the spectral sensitivity of RGB channels of the camera; (ii) determining weights of the RGB channels according to the inverse sensitivity by means of the recording settings of the camera; (iii) summing the weighted RGB channels of the camera image; (iv) multiplying the summed RGB channels by the broadband correction factor; (v) assigning angular ranges of the sky to image pixels of the camera by means of internal and/or external calibration values of the camera; (vi) weighting the image areas according to the projection into the horizontal and/or inclined plane; (vii) determining the angular range of the field of view of the horizontal and/or inclined plane from its inclination and orientation, and from the inclination and orientation of the sensor of the camera; (viii) determining the angular range of the solar disk from location and time; (ix) excluding the angular range of the solar disk from the angular range of the field of view of the horizontal and/or inclined plane; (x) integrating the image areas over the field of view; (xi) determining the diffuse radiation in the horizontal and/or inclined plane, in particular in the plane of the radiation sensor unit, by multiplication by a correction factor of the camera sensitivity.

In this way, the global irradiance and the diffuse radiation in the horizontal and/or inclined plane, and the direct radiation can be determined with high accuracy from the measurement data from the radiation sensor unit together with the measurement data from the camera.

According to a favorable configuration of the method, a determination of the correction factor of the camera sensitivity can be carried out with the steps of: (i) determining weights according to the sensitivity of each RGB channel of the camera by means of the spectral sensitivity of the RGB channels and the recording settings of the camera; (ii) determining weights according to human perception; (iii) summing the weighted RGB channels from the RGB camera image; (iv) assigning angular ranges of the sky to image pixels of the camera by means of the internal and/or external calibration values of the camera; (v) integrating the weighted RGB channels over the hemisphere of the sky above the plane of the camera; (vi) determining the correction factor of the camera sensitivity by calculating the ratio of the illuminance of the camera and the integrated weighted RGB camera image. In doing so, the global irradiance and the diffuse radiation in the horizontal and/or inclined plane, and the direct radiation can be determined with high accuracy from the measurement data from the camera together with the measurement data from the radiation sensor unit.

According to a further aspect of the invention, a device is proposed for carrying out a method for determining a global irradiance of solar radiation and/or at least one of the components thereof, in a plane, in particular in a horizontal plane and/or in a plane inclined with respect to the horizontal plane, wherein the components comprise direct radiation, diffuse radiation, radiation reflected on the ground, comprising at least one radiation sensor unit, a camera and an evaluation unit, which is provided for evaluating measurement data from the radiation sensor unit and/or from the camera.

The radiation sensor unit is provided for determining the irradiance of solar radiation in a field of view of 180° above a plane. The camera is provided for detecting a field of view of 180° over a plane.

The radiation sensor unit and the camera can advantageously be arranged on a north-south axis. In this case, the radiation sensor unit can be arranged north of the camera in the northern hemisphere and south of the camera in the southern hemisphere.

A pyranometer, in particular a thermopile pyranometer, can advantageously be used as the radiation sensor unit, and a cloud camera, such as, for example, a Mobotix Q25 surveillance camera, can be used as the camera. Both instruments are advantageously arranged horizontally leveled at the same height in the immediate vicinity of one another. In addition, the installation site should be selected expediently in such a way that other obstacles in the fields of view of the radiation sensor unit and camera are avoided.

According to the invention, with a fixed structure of the device, the global irradiance of solar radiation (GTI) and the diffuse radiation in horizontal and/or inclined planes, and the direct radiation can be determined using an image of the sky and the pyranometer. The GTI, the direct radiation and the diffuse radiation can be determined for any number of inclination angles and azimuth orientations of the planes. Changes in the angles over time are also possible in order to evaluate the planes of tracked receivers.

The image of the sky provides the radiance distribution of the sky in real time, excluding the sun disk. The diffuse irradiance (DHI) in the horizontal plane and the part of the diffuse irradiance (DifTI) originating from the sky in any other planes can be determined by an adapted weighting and integration of the radiance distribution. From the global irradiance measured by the pyranometer and the diffuse radiation calculated for this plane from the camera image, the DNI can be calculated using the known position of the sun and the GTI can be determined therefrom. The direct part of the irradiance DNI is projected purely geometrically into the respective plane. The diffuse part from the sky DifTI is obtained via the weighted integration described above. The part of the irradiance reflected on the ground into the inclined plane is determined by estimating the albedo of the ground and the known global irradiance GHI.

The radiance distribution of the sky can be determined directly via the camera image by means of the device according to the invention. In contrast to the prior art, no moving parts are used in the device for the precise determination of the DNI and the DHI, which means that the construction can be made significantly cheaper and more robust.

By means of the device consisting of or comprising camera and pyranometer, the global irradiance in the plane of the pyranometer can be determined directly via said pyranometer. In the case of a horizontally arranged pyranometer, said pyranometer directly measures the GHI. The camera image is used to determine the diffuse irradiance in arbitrary planes.

In the present case, the global radiation measured by means of a pyranometer can be converted into the irradiance in an arbitrary plane with high accuracy. The calculation of the GTI and the diffuse radiation in inclined planes is carried out via an adapted integration of the radiance distribution.

A commercially available pyranometer and an inexpensive fisheye surveillance camera can be used advantageously for the measuring system. In order to be able to use such a camera for measurements of the radiance distribution of the sky, the exposure control of the camera can be specifically adjusted. A suitable set of parameters for the camera control can be used to ensure that image characteristics relevant to the measurement remain largely constant, regardless of the observed scenery. Instead of an additional individual radiometric calibration of each cloud camera, the present measuring system during operation compares a diagnostic value of the illuminance output by the camera with a value calculated via the camera image, and corrects the sensitivity of the camera in real time. A correction for camera image gain is applied in the calculation.

The measurement system described here uses a combined measurement setup of pyranometer and camera at the same location.

With this arrangement, the radiance distribution of the sky is only used for converting between GHI, GTI in different planes and the respective components of the global radiation, direct radiation, diffuse radiation, radiation reflected on the ground. This ensures that the accuracy of the GTI measurement for small angles of inclination of the plane under consideration approaches the measurement accuracy of the pyranometer.

Due to the limited dynamic range, cloud cameras are poorly suited for determining the radiance distribution in the area of the solar disk and in the rest of the celestial dome at the same time.

The combined structure, on the other hand, advantageously makes it possible to exclude the area of the sun disk from the evaluation. The DNI used in the evaluation can be calculated from the measurement of the global irradiance and the diffuse radiation determined from the radiance distribution (excluding the solar disk).

The measurement setup serves to achieve a high level of accuracy in the radiation measurement. If there are lower demands concerning accuracy, changes can be made in the structure and in the evaluation.

Instead of a thermopile pyranometer, other measuring devices can optionally be used that can provide a measured value of the global irradiance, e. g. photodiode, photovoltaic reference cell. Instead of a Mobotix Q25 surveillance camera, another weatherproof fisheye camera with a field of view of 180°, comparable recording settings and with illuminance measurement can be used.

In the evaluation, the calculation of correction factors such as camera sensitivity via comparison of the illuminance, scattering effects depending on the direct normal irradiance can optionally be omitted.

According to a favorable configuration of the device, at least one sensor of the radiation sensor unit and at least one sensor of the camera can each be arranged in the horizontal plane in such a way that the field of view of the two sensors in each case is above the horizontal plane and flush with the horizontal plane.

This allows the solar radiation in the half-space above the horizontal plane to be measured in a suitable manner in order to then determine the global irradiance and the diffuse radiation in the horizontal and/or inclined plane, and the direct radiation.

According to a favorable configuration of the device, a distance between the radiation sensor unit and the camera is or can be set such that the sensor of the radiation sensor unit is visible in the field of view of the camera 20 with an elevation of at most 10°, preferably at most 5°. As a result, the part of the sky covered for the camera by the sensor of the radiation sensor unit is limited enough to determine the global irradiance in an inclined plane with sufficient accuracy.

According to a favorable configuration of the device, the radiation sensor unit and the camera can be coupled, so that measurement data is recorded by the radiation sensor unit and the camera in a synchronized manner. This allows the measurement data to be correlated appropriately during the evaluation for determining the global irradiance and the diffuse radiation in the horizontal and/or inclined plane, and the direct radiation.

According to a favorable configuration of the device, the camera can be designed so that at least the following characteristics are present:

a frame can be recorded in a fixed time pattern, in particular every half minute and full minute;
the at least one sensor of the camera can have a constant color temperature; the camera has a constant exposure time for each frame.

A predetermined minimum value for an average image brightness can be set for exposure control of the camera, with the exposure duration remaining unchanged at a higher image brightness.

In particular, the predetermined minimum value for an average image brightness can preferably be at most 10%, particularly preferably at most 8%, very particularly preferably at least 5%. This allows a high level of accuracy to be achieved when determining the global irradiance and the diffuse radiation in the horizontal and/or inclined plane, and the direct radiation.

According to a favorable configuration of the device, the camera can be designed to record the sky in the field of view. The image of the sky can provide the radiance distribution of the sky excluding the solar disk in real time. By means of an adapted weighting and integration of the radiance distribution, the diffuse irradiance (DHI) in the horizontal plane and the part of the diffuse irradiance (DifTI) originating from the sky in any other planes can be determined.

According to a favorable configuration of the device, the radiation sensor unit can have at least one of a pyranometer, in particular a thermopile pyranometer, a photodiode, and a photovoltaic reference cell.

Depending on the accuracy required when determining the global irradiance in an inclined plane, a compromise can be found between the effort required for the measurement technology and the costs.

According to a favorable configuration of the device, the radiation sensor unit can be designed such that a recording of measurement data by the radiation sensor unit is carried out with high temporal resolution, in particular with a temporal resolution of less than 10 s, preferably less than 5 s, particularly preferably less or equal to 1 s. This results in a sufficient temporal resolution when determining the solar radiation under changing radiation conditions.

According to a favorable configuration of the device, the radiation sensor unit can be designed to detect solar radiation in a wavelength range of 0.3 μm to 3 μm. This wavelength range is of particular interest for the design of photovoltaic systems and ranges from the lower limit of visible light to the short-wave part of the infrared range.

According to a favorable configuration of the device, the camera can be designed to detect the entire field of view in one recording. In particular, the camera can be designed as a surveillance camera and/or as a fisheye camera. With such a camera, the entire half-space above a plane can be recorded in a simple manner without mechanically moving parts. Such cameras with different resolutions are sometimes commercially available at low cost.

### BRIEF DESCRIPTION OF THE DRAWINGS

Further advantages result from the following description of the drawings. Exemplary embodiments of the invention are shown in the figures. The figures, the description and the claims contain numerous features in combination. The person skilled in the art will expediently also consider the features individually and combine them into further meaningful combinations.

As an example:

FIG. 1 shows a schematic structure of a device for determining a global irradiance of solar radiation and the components thereof direct radiation, diffuse radiation, radiation reflected on the ground in a horizontal and/or inclined plane according to an exemplary embodiment of the invention in a side view;

FIG. 2 shows the structure of the device according to FIG. 1 in an alternative arrangement, in which the planes of the radiation sensor unit and of the camera are inclined with respect to the horizontal plane;

FIG. 3 shows the structure of the device according to FIG. 1 in plan view;

FIG. 4 shows a flow chart of the method for determining an irradiance of solar radiation and the components thereof direct radiation, diffuse radiation, radiation reflected on the ground in a horizontal and/or inclined plane according to an exemplary embodiment of the invention;

FIG. 5 shows a flow chart for determining the diffuse irradiance originating from the sky in a plane;

FIG. 6 shows a flow chart for calculating the correction factor of the camera sensitivity based on a comparison of the illuminance output by the camera and the calculated illuminance; and

FIG. 7 shows a picture of the sky with a device according to an exemplary embodiment of the invention.

### DETAILED DESCRIPTION

In the figures, components of the same type or having the same effect are denoted by the same reference numerals. The figures only show examples and are not to be understood as limiting.

Directional terminology used below with terms such as “left”, “right”, “above”, “below”, “in front of”, “behind”, “after” and the like only serves to improve understanding of the figures and is in no way intended to constitute a limitation of generality. The components and elements shown, their design and use can vary according to the considerations of a person skilled in the art and can be adapted to the respective applications.

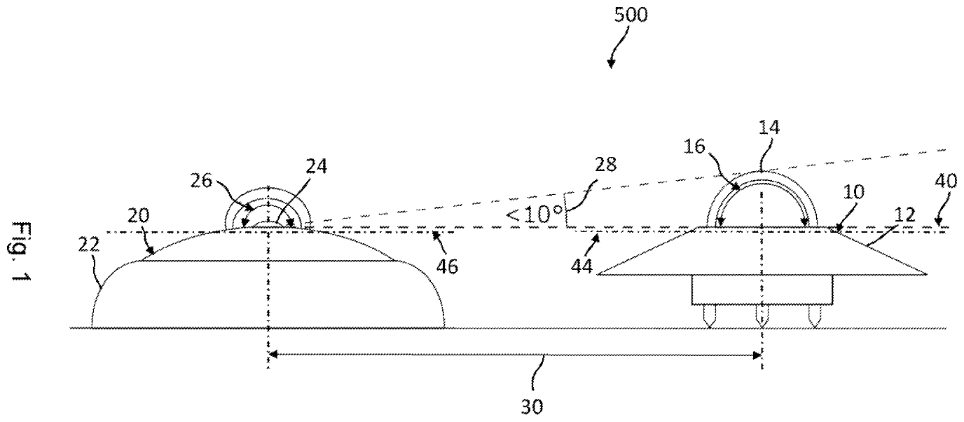

FIG. 1 shows a schematic structure of the device 500 for determining a global irradiance of solar radiation and the components thereof direct radiation, diffuse radiation and radiation reflected on the ground in a horizontal plane 40 and/or in a plane inclined with respect to a horizontal plane 40 according to an exemplary embodiment of the invention in a side view.

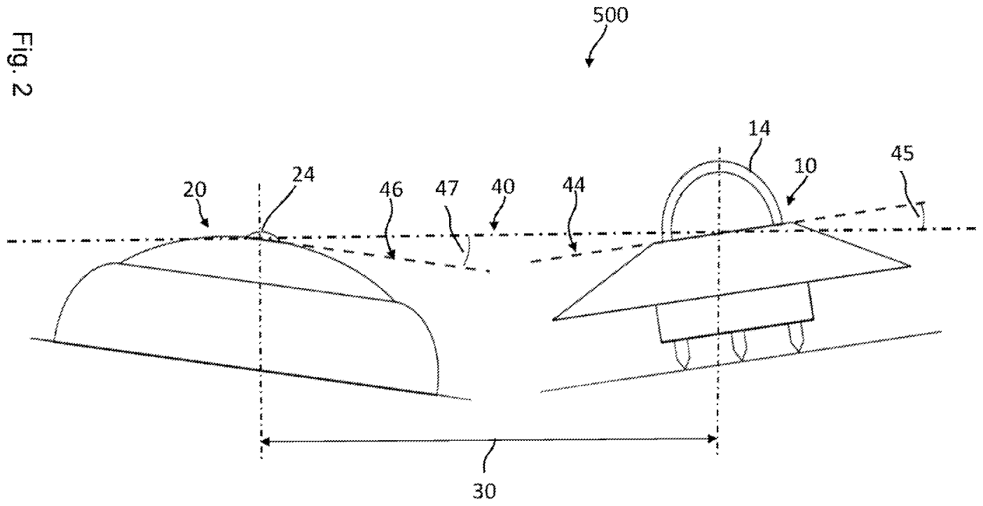

FIG. 2 shows the structure of the device 500 according to FIG. 1 in an alternative arrangement, in which planes 44, 46 of radiation sensor unit 10 and camera 20 are inclined with respect to the horizontal plane 40.

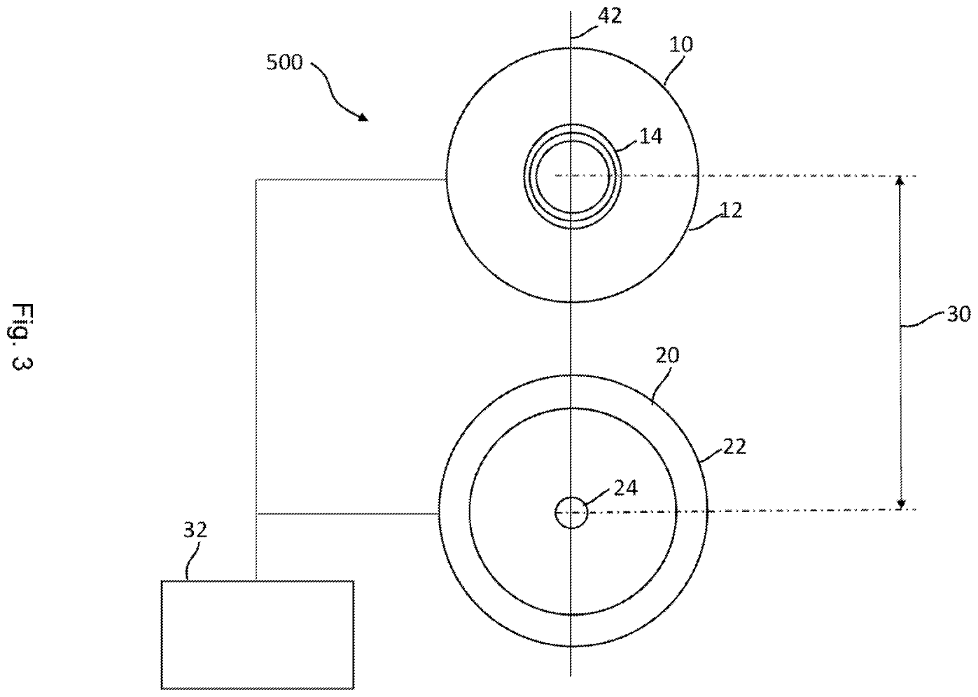

FIG. 3 shows the structure of the device 500 in plan view.

Device 500 comprises a radiation sensor unit 10, a camera 20, and an evaluation unit 32 (illustrated in FIG. 3), which is provided for evaluating measurement data from radiation sensor unit 10 and/or camera 20. Radiation sensor unit 10 is provided for determining the irradiance of solar radiation in a field of view 16 of 180°, i.e. the half-space above plane 44, and camera 20 is also provided for detecting a field of view 26 of 180°, i. e. the half-space above a plane 46.

When device 500 is set up as illustrated in FIG. 1, the two planes 44, 46 are oriented in the horizontal plane 40 and correspond to the horizontal plane 40.

When device 500 is set up as illustrated in FIG. 2, the planes 44, 46 of radiation sensor unit 10 and camera 20 are each inclined at an angle 45, 47 to horizontal plane 40. Angle 45, 47 can be set between 0° and 90°.

In this exemplary embodiment, radiation sensor unit 10 and camera 20 are arranged, for example, on a north-south axis 42, with radiation sensor unit 10 being arranged north of camera 20 in the northern hemisphere of the earth, as illustrated in FIG. 3. The radiation sensor unit 10 would be arranged south of camera 20 in the southern hemisphere of the earth.

Radiation sensor unit 10, which can be designed as a pyranometer, for example, in particular a thermopile pyranometer, comprises a housing 12, above which sensor 14 is arranged in order to detect the upper half-space with the field of view 16 of 180°.

The radiation sensor unit 10 is designed to detect solar radiation in a wavelength range of 0.3 μm to 3 μm.

Alternatively, radiation sensor unit 10 can also be designed in the form of a photodiode or photovoltaic reference cell if less stringent requirements are placed on the accuracy of the determination of the global irradiance.

Camera 20, which can be designed, for example, as a fisheye surveillance camera, in particular, for example, as a Mobotix Q25 surveillance camera or as a cloud camera, comprises a housing 22, above which sensor 24 is arranged to detect the upper half-space with field of view 16 of 180°. Camera 20 is preferably designed to record the sky in the field of view 26.

Camera 20 is advantageously designed in such a way that it can detect the entire field of view 26 in a single recording without the need for mechanically moving parts.

Both instruments are advantageously arranged horizontally leveled at the same height in the immediate vicinity of one another. In addition, the installation site is expediently chosen so that further obstacles in the fields of view of the radiation sensor unit and camera are avoided.

In the advantageous embodiment illustrated here, sensor 14 of radiation sensor unit 10 and sensor 24 of camera 20 are each arranged in horizontal plane 40 such that field of view 16, 26 of each of the two sensors 14, 24 is above horizontal plane 40 and flush with horizontal plane 40.

Distance 30 between radiation sensor unit 10 and camera 20 is set such that sensor 14 of radiation sensor unit 10 is visible in field of view 26 of camera 20 with an elevation 28 of at most 10°.

Radiation sensor unit 10 and camera 20 are coupled in such a way that measurement data is recorded by radiation sensor unit 10 and camera 20 in a synchronized manner. The measurement data is expediently evaluated in evaluation unit 32.

The measurement data are recorded by radiation sensor unit 10 with a high temporal resolution, in particular with a temporal resolution of less than 10 s, preferably less than 5 s, particularly preferably less than or equal to 1 s.

Camera 20 can expediently be configured in such a way that a frame is recorded in a fixed time pattern, in particular every half minute and every full minute. The at least one sensor 24 of camera 20 can advantageously have a constant color temperature. Camera 20 can conveniently have a constant exposure time for each frame. A predetermined minimum value of an average image brightness can be set for the exposure control of camera 20, with the exposure duration remaining unchanged at a higher image brightness.

In particular, the predefined minimum value of an average image brightness can preferably be at most 10%, particularly preferably at most 8%, very particularly preferably at least 5%.

The image of camera 20 provides the radiance distribution of the sky in real time, excluding the sun disk. The diffuse irradiance (DHI) in horizontal plane 40 and the part of the diffuse irradiance (DifTI) originating from the sky in any other planes can be determined by an adapted weighting and integration of the radiance distribution. The DNI can be calculated using the known position of the sun from the global irradiance measured by radiation sensor unit 10 designed as a pyranometer in plane 44 of the pyranometer and the diffuse radiation in this plane 44 calculated using the camera image, and GTI can be determined therefrom: The direct part of the irradiance DNI is projected purely geometrically into the respective plane. The diffuse part from the sky DifTI is obtained via the weighted integration described above. The part of the irradiance reflected on the ground into the inclined plane is determined by estimating the albedo of the ground and the global irradiance GHI in the horizontal plane determined by the pyranometer and the camera.

By means of the device described, the radiance distribution of the sky can be determined directly via the camera image.

By means of the device described in FIGS. 1 to 3 consisting of or comprising camera 20 and radiation sensor unit 10, in particular in the form of a pyranometer, the global radiation in plane 44 of radiation sensor unit 10 can be determined directly via radiation sensor unit 10, which is designed as a pyranometer, for example. The camera image is used to determine the diffuse irradiance in arbitrary planes instead of just in the horizontal.

In addition, the direct radiation is determined by comparing the global radiation of radiation sensor unit 10, designed for example as a pyranometer, with the diffuse radiation of the camera image, evaluated for plane 44 of the pyranometer. The global radiation measured by means of radiation sensor unit 10 designed, for example, as a pyranometer can thus in the present case be converted with high accuracy into the irradiance in an arbitrary plane. The calculation of the GTI and the diffuse radiation in inclined planes is carried out via an adapted integration of the radiance distribution.

The device described in FIGS. 1 to 3 uses a commercially available pyranometer and an inexpensive fisheye surveillance camera. The exposure control of the camera can be specifically adapted in order to be able to use such a camera for measurements of the radiance distribution of the sky. A suitable set of parameters for the camera control can be used to ensure that image characteristics relevant to the measurement remain lamely constant, regardless of the observed scenery. Instead of an additional individual radiometric calibration of each camera 20, the present measuring system during operation compares a diagnostic value of the illuminance output by camera 20 with a value calculated via the camera image, and corrects the sensitivity of the camera in real time. A correction for camera image gain is applied in the calculation.

The device described in FIGS. 1 to 3 uses a combined measurement setup of radiation sensor unit 10 and camera 20 at the same location. With this arrangement, the radiance distribution of the sky is used for converting between the global radiation measurement of pyranometer 10 and GHI, GTI, and between these quantities and their respective components, direct radiation, diffuse radiation, radiation reflected on the ground.

This ensures that the accuracy of the GTI measurement for small angles of inclination of the plane under consideration approaches the measurement accuracy of the pyranometer. The combined structure makes it possible to exclude the area of the solar disk from the evaluation. The DNI used in the evaluation can be calculated from the measurement of the global radiation and the diffuse radiation determined from the radiance distribution (excluding the solar disk).

The device described in FIGS. 1 to 3 serves to achieve a high level of accuracy in the radiation measurement. If there are lower demands concerning accuracy, changes can be made in the structure and in the evaluation.

Instead of a thermopile pyranometer, other measuring devices can optionally be used that can provide a measured value of the GHI, e. g. photodiode, photovoltaic reference cell. Instead of a Mobotix Q25 surveillance camera, another weatherproof fisheye camera with a field of view of 180°, comparable recording settings and with illuminance measurement can be used.

In the evaluation, the calculation of correction factors such as camera sensitivity via comparison of the illuminance, scattering effects depending on the direct normal irradiance can then optionally be omitted.

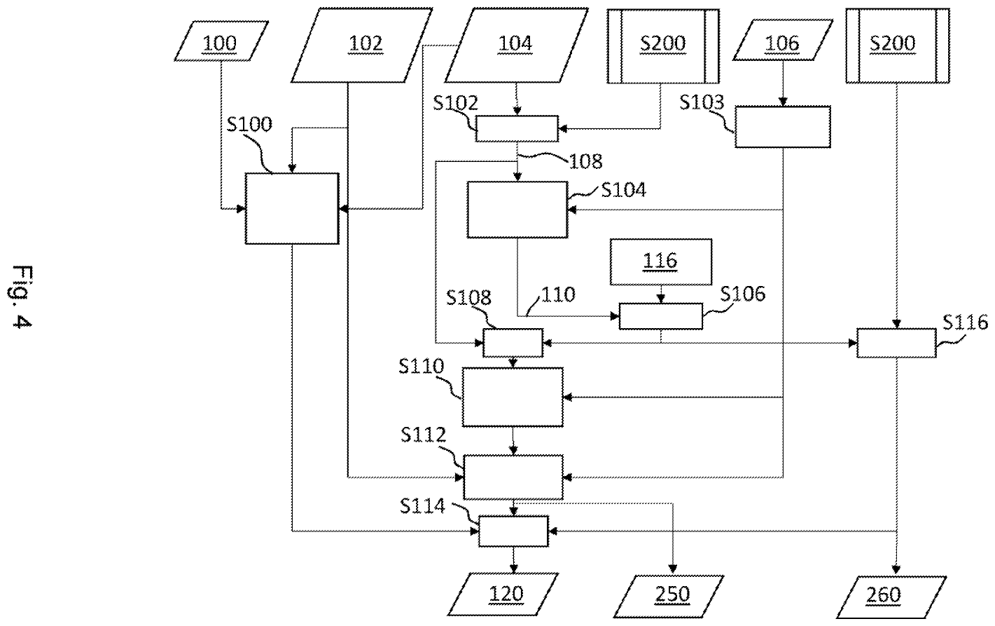

FIG. 4 shows a flow chart of the method for determining an irradiance of solar radiation in a plane inclined with respect to a horizontal plane 40 according to an exemplary embodiment of the invention. Here, a device with a radiation sensor unit 10, a camera 20 and an evaluation unit 32 is used, as illustrated in FIGS. 1 to 3. A global irradiance of the solar radiation in a plane inclined with respect to horizontal plane 40 is determined by means of the method. Furthermore, the method provides the DNI and the diffuse radiation in an arbitrary plane. The method can also be used to calculate one of these quantities.

As described above, a pyranometer, in particular a thermopile pyranometer, can advantageously be used as radiation sensor unit 10 and a cloud camera such as a Mobotix Q25 surveillance camera, for example, can be used as camera 20. Both instruments are advantageously arranged horizontally leveled at the same height in the immediate vicinity of one another.

The red-green-blue (RGB) color channels of the image of the sky are weighted and summed. The weighting of the channels ensures that the camera's 20 sensitivity is as uniform as possible in the visible wavelength range. This gray value is multiplied by a broadband correction to account for radiation at wavelengths outside the measurement range of camera 20.

Using a geometric internal and external standard calibration for cloud cameras, a sky range (azimuth and zenith angle) is specified for each pixel of the camera image. As a result, an estimate of the radiance distribution of the sky is obtained.

A luminance distribution is calculated analogously to the radiance distribution. For this purpose, the RGB color channels are weighted according to the sensitivity of the human eye before summation. Integration of the luminance distribution over all angular ranges provides a measured value of the illuminance. The illuminance output by camera 20 and calculated using the camera image are compared. The radiance distribution is scaled according to the ratio of both values in order to compensate for an influence of the camera control on the sensitivity of camera 20.

The area of the solar disk is masked. For an evaluated sensor plane, each area of sky in the radiance image is weighted according to a projection into the plane. Integration of the radiance distribution over all areas of the sky that are in the field of view of the inclined plane provides the diffuse irradiance of the respective plane originating from the sky.

The horizontal diffuse irradiance in plane 44 of radiation sensor unit 10 is calculated accordingly. The direct normal irradiance (DNI) is calculated from the comparison to the horizontal global irradiance measured by means of a pyranometer and with knowledge of the current position of the sun.

To correct for refraction effects in the lens of camera 20, the first estimate of the diffuse irradiance in plane 44 of radiation sensor unit 10 and all other calculated diffuse irradiances are reduced by a part of the DNI (lens refraction correction). Accordingly, the correction is added to the direct radiation in plane 44 of radiation sensor unit 10. The DNI is then recalculated.

Finally, the GTI in an evaluated plane results from a direct part, a diffuse part from the sky and a part reflected on the ground. The DNI is projected into the evaluated plane and thus results in the direct part. The diffuse irradiance is calculated from the camera image for this plane, as described above. The reflected part is obtained as GHI multiplied by the albedo of the ground and the term

(1—cos(inclination angle of the inclined plane against horizontal))/2.

According to the specified method, for converting the global irradiance of the solar radiation determined with radiation sensor unit 10 in plane 44 of radiation sensor unit 10 into the irradiance 120 and/or respective components thereof, direct radiation 250, diffuse radiation 260, radiation reflected on the ground, in the horizontal plane 40 and/or in the plane inclined with respect to the horizontal plane 40, at least one of the quantities of radiation reflected on the ground and/or diffuse radiation 220 and/or the position of the sun in the radiation measurement and/or a sensor-specific correction factor, which in particular lens parameters of the camera 20 includes, can be used. Factors of the position of the sun that influence the radiation measurement can be taken into account in the conversion.

Furthermore, according to the specified method, for converting measurement data from camera 20 at least one of the quantities of a ratio 210 of a broadband radiation to the part of the radiation registered by camera 20 and/or a spectral intensity 202 of RGB channels of camera 20 and/or an internal and/or external calibration 208 of camera 20 and/or an inclination and orientation 102 of sensor 24 of camera 20 and/or the position of the sun in the radiation measurement and/or a camera sensitivity, which is determined from an illuminance 300 of the camera 20 and/or the spectral sensitivity 202 of the RGB channels and/or recording settings 204 and/or RGB camera image 206 and/or internal and/or external calibration 208 of camera 20 can be used. Factors of the position of the sun that influence the radiation measurement can be taken into account in the conversion.

FIG. 4 shows the individual steps for determining global irradiance 120 of the solar radiation and/or its respective components, direct radiation 250, diffuse radiation 260, radiation reflected on the ground, in horizontal plane 40 and in the plane inclined with respect to horizontal plane 40.

In step S100, the radiation reflected on the ground is determined using albedo 100, inclination and orientation 102 of the inclined plane, and a measured value 104 of the global irradiance in plane 44 of radiation sensor unit 10.

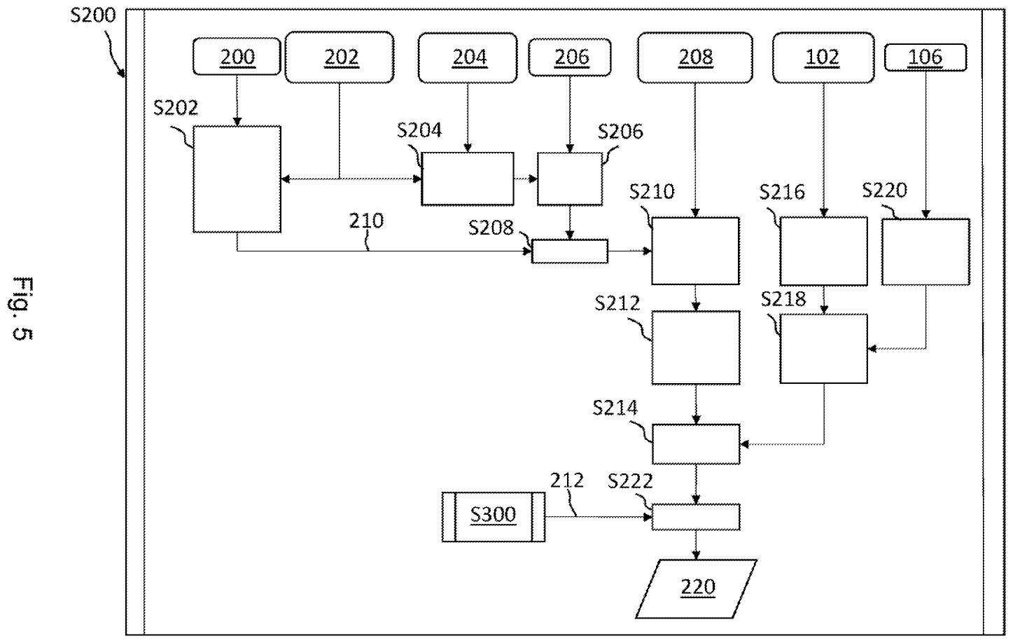

In step S102, direct radiation 108 in plane 44 of radiation sensor unit 10 is determined by subtracting S102 the measured value of diffuse radiation 220, evaluated for plane 44 of radiation sensor unit 10, from the global irradiance in plane 44 of radiation sensor unit 10. Diffuse radiation 220 in plane 44 of radiation sensor unit 10 is previously determined in module S200, described in FIG. 5.

The direct normal irradiance 110 is then determined by reversing the projection in step S104 into plane 44 of radiation sensor unit 10 by means of location and time 106 of the position of the sun calculated in step S103.

In step S106, direct normal irradiance 110 is multiplied by a correction factor, which in particular comprises lens parameters of camera 20. A lens refraction correction is obtained.

In step S108, direct radiation 108 in plane 44 of radiation sensor unit 10 and the lens refraction correction are added, and in step S110 the projection into plane 44 of radiation sensor unit 10 is reversed, taking into account the position of the sun calculated in step S103. Then, in step S112, this direct normal irradiance 108 is projected into the horizontal and/or inclined plane, taking into account the inclination and orientation 102 thereof, in order to obtain the corrected measured value of direct radiation 250 in this plane.

In step S116, the lens refraction correction is subtracted from diffuse radiation 220, evaluated for the inclined or horizontal plane, determined in module S200, as described in FIG. 5. In doing so, a corrected measured value of diffuse radiation 260 in the relevant inclined or horizontal plane is determined.

Thereafter, in step S114, global irradiance 120 in the horizontal and/or inclined plane can be determined by summing the radiation reflected on the ground from step S100, direct radiation 250 as a component of global irradiance 120 in the horizontal and/or inclined plane from step S112, and the diffuse radiation 260 as a component of global irradiance 120, evaluated for the horizontal and/or inclined plane, corrected in step S116.

FIG. 5 shows a flow chart for determining diffuse irradiance 220 originating from the sky in the horizontal or inclined plane, in particular in plane 44 of radiation sensor unit 10 by means of module S200.

In step S202, a broadband correction factor 210 is first determined from the ratio of broadband radiation to the part registered by camera 20 by means of daylight spectrum 200 and spectral sensitivity 202 of RGB channels of camera 20.

For this purpose, in step S204, weights of the RGB channels are determined according to the inverse sensitivity by means of recording settings 204 of camera 20.

The weighted RGB channels of camera image 206 can thus be summed up in step S206.

The summed RGB channels are multiplied by the broadband correction factor 210 in step S208.

In step S210, angular ranges of the sky can thus be assigned to image pixels of camera 20 by means of internal and/or external calibration values 208 of camera 20.

Thereafter, in step S212, these image areas are weighted according to the projection into the horizontal and/or inclined plane.

At the same time, in step S216, the angular range of the field of view of the horizontal and/or inclined plane is determined from inclination and orientation 102 of this plane, while in step S220 the angular range of the sun disk is determined from location and time 106.

In step S218, the angular range of the solar disk can then be excluded from the angular range of field of view 26 of the horizontal and/or inclined plane.

Then, in step S214, the image areas from step S212 are integrated over the field of view of the horizontal or inclined plane.

Diffuse radiation 220 in the horizontal or inclined plane, in particular in plane 44 of radiation sensor unit 10 can then be calculated in step S222 by multiplication with correction factor 212 of the camera sensitivity, which was previously determined by means of module S300.

In the exemplary embodiment illustrated in FIG. 5, diffuse radiation 220 is determined in the horizontal or inclined plane, in particular in plane 44 of radiation sensor unit 10. Using module S200, diffuse radiation 220 can be determined in the arbitrary horizontal and/or inclined plane.

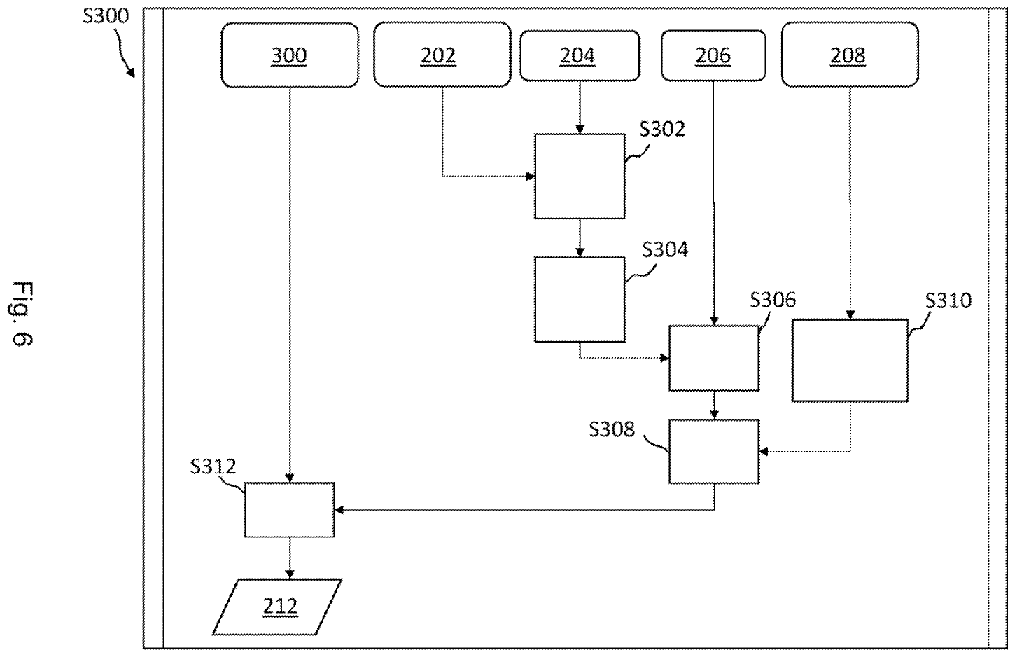

FIG. 6 shows a flow chart for calculating correction factor 212 of the camera sensitivity based on a comparison of the illuminance output by the camera and the calculated illuminance using module S300.

First, in step S302, weights are determined according to the sensitivity of each RGB channel of camera 20 by means of spectral sensitivity 202 of the RGB channels and exposure settings 204 of camera 20.

Then, in step S304, weights are determined therefrom according to human perception.

By means of these weights, RGB channels from RGB camera image 206 can then be weighted and summed up in step S306.

In parallel, in step S310, angular ranges of the sky are assigned to image pixels of camera 20 by means of internal and/or external calibration values 208 of camera 20.

Thereafter, in step S308, the weighted RGB channels from step S306 are integrated over the hemisphere of the sky.

Correction factor 212 of the camera sensitivity can thus be determined in step S312 by calculating the ratio of illuminance 300 of camera 20 and the integrated weighted RGB camera image.

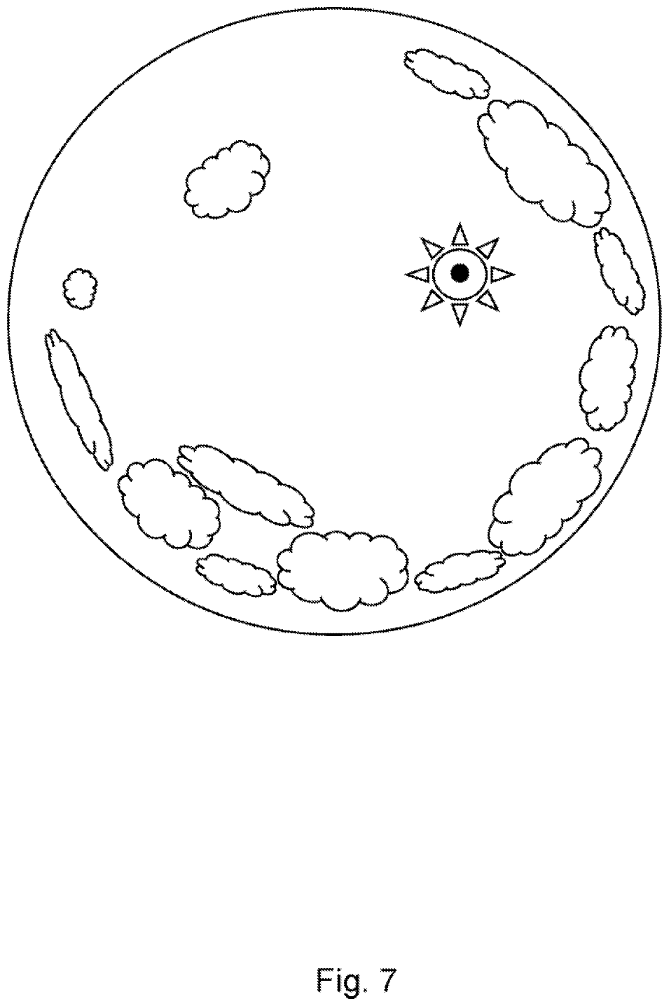

FIG. 7 shows a recording of the sky with clouds, recorded with a camera 20 of a device 500 according to an exemplary embodiment of the invention. A typical recording of fisheye optics with a field of view of 180° in the half-space above horizontal is illustrated. Near the zenith, the luminous, unspecified solar disk can be seen, while at the edge of the image, i.e. more in the horizon area, unspecified clouds can be seen.

### REFERENCE NUMERALS

10 radiation sensor unit

12 housing

14 sensor

16 field of view

20 camera

22 housing

24 sensor

26 field of view

28 elevation

30 distance

32 evaluation unit

40 horizontal plane

42 north-south axis

44 plane of radiation sensor unit

45 angle of inclination

46 plane of camera

47 angle of inclination

100 albedo

102 inclination, orientation of the sensor

104 measured value of global irradiance in horizontal plane

106 location, time

108 direct radiation in horizontal plane

110 direct normal irradiance

120 global irradiance in inclined plane

200 daylight spectrum

202 spectral sensitivity of the RGB channels

204 camera recording settings

206 RGB camera image

208 calibration of the camera

210 broadband correction factor

212 correction factor of camera sensitivity

220 diffuse radiation in sensor plane

250 direct radiation in an arbitrary plane

260 diffuse radiation in an arbitrary plane

300 illuminance of the camera

500 device

1-19. (canceled)

20. A method for the determination of a global irradiance of solar radiation in a plane inclined with respect to a plane of a radiation sensor unit and/or at least one of the components of the global irradiance in a horizontal plane and/or in a plane inclined with respect to the horizontal plane, the components comprising direct radiation, diffuse radiation, radiation reflected on the ground, with a device comprising at least the radiation sensor unit, a camera and an evaluation unit which is provided for evaluating measurement data from the radiation sensor unit and/or from the camera, comprising
determining, with the radiation sensor unit, the irradiance of solar radiation in a field of view of 180° above the plane of the radiation sensor unit,
detecting, with the camera, a field of view of 180° over a plane of the camera,
measuring a global irradiance of the solar radiation in the plane of the radiation sensor unit and converting the global irradiance of the solar radiation into the global irradiance in the plane inclined with respect to the plane of the radiation sensor unit and/or into one or more of the components of the global irradiance in the horizontal plane and/or in the plane inclined with respect to the horizontal plane, and
including image information of the camera for converting the global irradiance in the plane of the radiation sensor unit into the global irradiance and/or into at least one of the components thereof in this plane or in the horizontal plane and/or in the plane inclined with respect to the horizontal plane form the measurement data from the radiation sensor unit by using an intensity of RGB channels of the camera for converting measured values of the camera.

21. The method according to claim 20, wherein, for the conversion of the irradiance of the solar radiation determined with the radiation sensor unit in the plane of the radiation sensor unit into the global irradiance and/or into at least one of the components thereof in the horizontal plane and/or in the plane inclined with respect to the horizontal plane, at least one of the quantities of
radiation reflected on the ground, and/or
diffuse radiation in the horizontal plane and/or in the plane inclined with respect to the horizontal plane, in particular in the plane of the radiation sensor unit, and/or
the position of the sun in the radiation measurement, and/or
a sensor-specific correction factor, which comprises in particular lens parameters of the camera,
is used.

22. The method according to claim 20, wherein for the conversion of measured values of the camera at least one of the quantities of
a ratio of a broadband radiation to the part of the radiation registered by the camera, and/or
an internal and/or external calibration of the camera and/or
an inclination and orientation of the sensor of the camera and/or
an inclination and orientation of the inclined plane and/or
the position of the sun in the radiation measurement and/or
a camera sensitivity, which is determined from an illuminance of the camera and/or the spectral sensitivity of the RGB channels and/or recording settings and/or the RGB camera image and/or the internal and/or external calibration of the camera,
is used.

23. The method according to claim 20, comprising determining the direct radiation as a component of the global irradiance in an arbitrary plane, including:
(i) determining a radiation reflected on the ground by means of albedo, inclination and orientation of the inclined plane, and a measured value of the global irradiance in the plane of the radiation sensor unit;
(ii) determining the direct radiation in the plane of the radiation sensor unit by subtracting the measured value of the diffuse radiation, evaluated from the measurement data from the camera for the plane of the radiation sensor unit, and the radiation reflected on the ground, evaluated for the plane of the radiation sensor unit, from the global irradiance in the plane of the radiation sensor unit;
(iii) determining a direct normal irradiance by reversing the projection into the plane of the radiation sensor unit by means of the position of the sun calculated from location and time;
(iv) determining a lens refraction correction by multiplying the direct normal irradiance by a correction factor, which comprises lens parameters of the camera;
(v) determining the corrected direct radiation by adding the direct radiation in the plane of the radiation sensor unit and the lens refraction correction, and inverting the projection into the plane of the radiation sensor unit and projection into the arbitrary plane.

24. The method according to claim 20, comprising determining the diffuse radiation as a component of the global irradiance in an arbitrary plane, including:
(i) determining a radiation reflected on the ground by means of albedo, inclination and orientation of the inclined plane, and a measured value of the global irradiance in the plane of the radiation sensor unit;
(ii) determining the direct radiation in the plane of the radiation sensor unit by subtracting the measured value of the diffuse radiation, evaluated from the measurement data from the camera for the plane of the radiation sensor unit, and the radiation reflected on the ground, evaluated for the plane of the radiation sensor unit, from the global irradiance in the plane of the radiation sensor unit;
(iii) determining a direct normal irradiance by reversing the projection into the plane of the radiation sensor unit by means of the position of the sun calculated from location and time;
(iv) determining a lens refraction correction by multiplying the direct normal irradiance by a correction factor, which comprises lens parameters of the camera; and
(v) determining the corrected diffuse radiation by subtracting the lens refraction correction from the diffuse radiation, evaluated for the arbitrary plane.

25. The method according to claim 20, wherein the determination of the global irradiance of the solar radiation in the horizontal and/or inclined plane comprising:
(i) determining a radiation reflected on the ground by means of albedo, inclination and orientation of the inclined plane, and a measured value of the global irradiance in the plane of the radiation sensor unit;
(ii) determining the direct radiation in the plane of the radiation sensor unit by subtracting the measured value of the diffuse radiation, evaluated from the measurement data from the camera for the plane of the radiation sensor unit, and the radiation reflected on the ground, evaluated for the plane of the radiation sensor unit, from the global irradiance in the plane of the radiation sensor unit;
(iii) determining a direct normal irradiance by reversing the projection into the plane of the radiation sensor unit by means of the position of the sun calculated from location and time;
(iv) determining a lens refraction correction by multiplying the direct normal irradiance by a correction factor, which comprises lens parameters of the camera;
(v) adding the direct radiation in the plane of the radiation sensor unit and the lens refraction correction, and inverting the projection into the plane of the radiation sensor unit and projection into the horizontal and/or inclined plane;
(vi) subtracting the lens refraction correction from the diffuse radiation, evaluated for the horizontal plane and/or the inclined plane;
(vii) determining the global irradiance in the horizontal and/or inclined plane by summing the radiation reflected on the ground, the direct radiation in the horizontal and/or inclined plane, and the diffuse radiation, evaluated for the horizontal and/or inclined plane.

26. The method according to claim 21, wherein a determination of the diffuse radiation in the horizontal and/or inclined plane comprises:
(i) determining a broadband correction factor from the ratio of broadband radiation to the part registered by the camera by means of the daylight spectrum and the spectral sensitivity of RGB channels of the camera;
(ii) determining weights of the RGB channels according to the inverse sensitivity by means of the recording settings of the camera;
(iii) summing the weighted RGB channels of the camera image;
(iv) multiplying the summed RGB channels by the broadband correction factor;
(v) assigning angular ranges of the sky to image pixels of the camera by means of internal and/or external calibration values of the camera;
(vi) weighting the image areas according to the projection into the horizontal and/or inclined plane;
(vii) determining the angular range of the field of view of the horizontal and/or inclined plane from its inclination and orientation, and from the inclination and orientation of the sensor of the camera;
(viii) determining the angular range of the solar disk from location and time;
(ix) excluding the angular range of the solar disk from the angular range of the field of view of the horizontal and/or inclined plane;
(x) integrating the image areas over the field of view;
(xi) determining the diffuse radiation in the horizontal and/or inclined plane, in particular in the plane of the radiation sensor unit, by multiplication by a correction factor of the camera sensitivity.

27. The method according to claim 26, wherein a determination of the correction factor of the camera sensitivity comprises:
(i) determining weights according to the sensitivity of each RGB channel of the camera by means of the spectral sensitivity of the RGB channels and the recording settings of the camera:
(ii) determining weights according to human perception;
(iii) summing the weighted RGB channels from the RGB camera image;
(iv) assigning angular ranges of the sky to image pixels of the camera by means of the internal and/or external calibration values of the camera;
(v) integrating the weighted RGB channels over the hemisphere of the sky above the plane of the camera;
(vi) determining the correction factor of the camera sensitivity by calculating the ratio of the illuminance of the camera and the integrated weighted RGB camera image.

28. A device for the carrying out of a method according to claim 20, comprising at least one radiation sensor unit, a camera and an evaluation unit which is provided to evaluate measurement data from the radiation sensor unit and/or from the camera,
wherein the radiation sensor unit is provided for the determination of the irradiance of solar radiation in a field of view of 180° above a plane of the radiation sensor unit,
wherein the camera is provided for the detection of a field of view of 180° over a plane of the camera,
wherein a combined measurement setup of radiation sensor unit and camera is utilized at the same location;
wherein a global irradiance of the solar radiation is measured in a plane of the radiation sensor unit and converted into the global irradiance in a plane inclined with respect to the plane of the radiation sensor unit and/or into one or more of the components of the global irradiance in the horizontal plane and/or in the plane inclined with respect to the horizontal plane,
wherein image information of the camera is included for converting the global irradiance in the plane of the radiation sensor unit into the global irradiance and/or into at least one of the components thereof in this plane or in the horizontal plane and/or in the plane inclined with respect to the horizontal plane from the measurement data from the radiation sensor unit, by using an intensity of RGB channels of the camera for converting measured values of the camera.

29. The device according to claim 28, wherein at least one sensor of the radiation sensor unit and at least one sensor of the camera are each arranged in the horizontal plane in such a way that the field of view of the two sensors in each case is above the horizontal plane and flush with the horizontal plane.

30. The device according to claim 28, wherein a distance between the radiation sensor unit and the camera is or can be set such that the sensor of the radiation sensor unit is visible in the field of view of the camera with an elevation of at most 10°, preferably at most 5°.

31. The device according to claim 28, wherein the radiation sensor unit and the camera are coupled, so that measurement data is recorded by radiation sensor unit and camera in a synchronized manner.

32. The device according to claim 28, wherein the camera is designed so that at least the following characteristics are present:
a frame is recorded in a fixed time pattern, in particular every half minute and full minute;
the at least one sensor of the camera has a constant color temperature;
the camera has a constant exposure time for each frame;
a predetermined minimum value for an average image brightness is set for exposure control of the camera, with the exposure duration remaining unchanged at a higher image brightness.

33. The device according to claim 28, wherein the camera is designed to record the sky in the field of view.

34. The device according to claim 28, wherein the radiation sensor unit has at least one of a pyranometer, a photodiode, and a photovoltaic reference cell.

35. The device according to claim 28, wherein the radiation sensor unit is designed such that a recording of measurement data by the radiation sensor unit is carried out with high temporal resolution.

36. The device according to claim 29, wherein the radiation sensor unit is designed to detect solar radiation in a wavelength range of 0.3 μm to 3 μm.

37. The device according to claim 29, wherein the camera is designed to detect the entire field of view in one recording.
